(19) United States
(12) Patent Application Publication
(10) Pub. No.: US 2011/0181713 A1
(43) Pub. Date: Jul. 28, 2011

(54) WET DETECTION DEVICE, WET DEVICE, AND WET DETECTING METHOD

(76) Inventor: ATSUSHI OHKUBO, Tokyo (JP)

(21) Appl. No.: 13/013,200

(22) Filed: Jan. 25, 2011

(30) Foreign Application Priority Data
Jan. 25, 2010 (JP) 13486/2010

(51) Int. Cl. H04N 7/18

(52) U.S. Cl. 348/135; 348/E07.085

(57) ABSTRACT

A wet detection device includes an imaging unit, a wet detection unit and a liquid amount detection unit. The imaging unit images a target object detecting a wet condition and a standard object as a standard for a reflectivity determination under the same environment. The wet detection unit includes a function to detect a reflectivity of light irradiated toward the target object based on each image data of the target object and the standard object based on the imaging of the imaging unit and based on information representing a reflectivity of light irradiated toward the standard object found in advance. Further the wet detection unit includes a function to detect a wet condition of the target object based on the reflectivity of light irradiated toward the target object. The liquid amount detection unit includes a function to calculate an amount of liquid compensating for a wet deficiency of the target object compared with a predetermined wet condition based on the detected wet condition of the target object.

This application is based upon and claims the benefit of priority from Japanese Patent Application No. 2010-013486, filed on Jan. 25, 2010, the disclosure of which is incorporated herein in its entirety by reference.

### TECHNICAL FIELD

The present invention relates to a wet detection device, a wet device and a wet detecting method which detect a wet condition of a target object.

### BACKGROUND ART

A wet detection device is a device which detects a wet condition of a target object. As a composition of the wet detection device, various configurations are proposed. For example, Japanese Patent Application Laid-Open No. 2002-148184 (patent document 1) discloses a method as a method which can properly detects a condition of a road surface at a low cost as follows. That is, in the method of the patent document 1, a camera photographs a reflected light from an area of the road surface having a laser beam radiated from a radiating device. Then, a data extraction circuit extracts the luminance of the reflected light and a reflection pattern from an image of the photographed area. Further, a comparison determining circuit determines whether the road surface is dry or freezing based on the luminance of the reflected light and the reflection pattern extracted by the data extraction circuit and a reference reflected light luminance and a reference reflection pattern previously stored in a data base. Then, an information on the frozen road is provided to a driver of a passing vehicle by a warning display plate.

Japanese Patent Application Laid-Open No. 2002-162343 (patent document 2) discloses a road surface condition judgment equipment as follows. That is, by a visual camera attached to watch the road surface by bird's eye, the equipment of the patent document 2 for example photographs beforehand the road surface corresponding to each of weather condition (i.e. fine weather, cloudy weather, nighttime, etc.) as an external factor when judging wet. Then, the equipment of the patent document 2 stores images of the road surface thereof as reference images.

The equipment of the patent document 2 compares a new examination image photographed to the reference images thereof. By this comparison, the equipment of the patent document 2 judges which the reference image is the closest to the examination image. Then, the equipment of the patent document 2 detects the wet or dry condition of the road surface in the examination image based on the result of judgment. The equipment of the patent document 2 is disclosed as not to be limited to a narrow area, to meet the requirements for wanting to monitor the road surface condition in a wide area, and to have capable of reducing the cost.

Japanese Patent Application Laid-Open No. 2009-42115 (patent document 3) discloses a road surface condition estimation device for a vehicle as follows. That is, the device of the patent document 3 sets a threshold value for determination on the basis of a road surface moisture within a predetermined distance from the own vehicle detected by a first sensor and a road surface brightness within the predetermined distance from the own vehicle detected by a second sensor. The device of the patent document 3 compares the brightness of the remote road surface spaced from the own vehicle equal to or more than the predetermined distance detected by the first sensor with the threshold value for determination. The device of the patent document 3 estimates the road surface condition to be the dry and wet condition of the remote road surface on the basis of such comparison. The device of the patent document 3 is disclosed as to be capable of estimating the dry and wet condition of the remote road surface with higher accuracy by reducing an effect from the surrounding environment.

Japanese Patent Application Laid-Open No. 1993(H5)-209861 (patent document 4) discloses a configuration as follows. That is, in the configuration of the patent document 4, a personal computer controls to peripheral devices constituting a sample concentration measurement system by a biosensor, in order to simplify execution. The personal computer hereof executes signal processing, a statistical processing, filing, etc., by inputting sensor output signals. The effect of the configuration disclosed in the patent document 4 is an effect of not only having an analysis possible only with an operation of a keyboard of a personal computer, but also having a signal processing and statistic processing possible.

Japanese Patent Application Laid-Open No. 997(H9)-159602 (patent document 5) discloses a dry and wet detection system for an object surface as follows. That is, the system of the patent document 5 is intended to provide a system for accurately detecting dry and wet condition of the object surface and for determining a required watering place in real time. The system has a light source for illuminating the object surface obliquely, a polarization filter transmitting only a light in specific oscillatory direction of reflected light from the object surface, and a camera for converging a polarized reflected light. Further, the system has a computer performing arithmetic processing and image processing based on the converged light, a display for displaying results of arithmetic processing and image processing, and a recording unit for recording the results. The computer subtracts a vertically polarized image from a horizontally polarized image and averages thereof, and subtracts a threshold value from the subtracted value and averages thereof.

### SUMMARY

An exemplary object of the present invention is to provide a wet detection device, a wet device, and a wet detecting method to determine a wet (moisture, humidity) condition of a target object accurately and to calculate an amount of liquid (the drip amount) which drops to the target object so that it will be a predetermined wet condition.

That is, an exemplary aspect of the present invention includes an imaging unit which images a target object detecting a wet condition and a standard object as a standard for a reflectivity determination under the same environment, a wet detection unit which detects a reflectivity of light irradiated toward the target object based on each image data of the target object and the standard object by the imaging unit and based on information representing a reflectivity of light irradiated toward the standard object found in advance and detects a wet condition of the target object on the basis of the reflectivity of light irradiated toward the target object, and a liquid amount detection unit which calculates an amount of liquid compensating for a wet deficiency of the target object compared with a predetermined wet condition based on the detected wet condition of the target object.

Another exemplary aspect of the present invention further includes a liquid supplying device which supplies an amount of liquid detected by the wet detection device to a target object, in addition to aforementioned configuration.

Further exemplary aspect of the present invention includes:

imaging a target object detecting a wet condition and a standard object as a standard for the reflectivity determination under the same environment;

detecting a reflectivity of light irradiated toward the target object based on each image data of the target object and the standard object by the imaging and based on information representing a reflectivity of light irradiated toward the standard object found in advance and detecting a wet condition of the target object on the basis of the reflectivity of light irradiated toward the target object; and

calculating an amount of liquid compensating for a wet deficiency of the target object compared with a predetermined wet condition based on the detected wet condition of the target object.

### BRIEF DESCRIPTION OF THE DRAWINGS

Exemplary features and advantages of the present invention will become apparent from the following detailed description when taken with the accompanying drawings in which:

FIG. 1A is a block diagram showing a simplified configuration of a wet detection device according to a first exemplary embodiment of the present invention;

FIG. 1B is a block diagram showing a simplified configuration of a wet device according to the first exemplary embodiment of the present invention;

FIG. 2 is an explanatory diagram showing an example of a relation between a wetness degree (a wet condition) and a reflectivity of an object;

FIG. 3 is a simplified diagram showing a configuration of a wet device according to a second exemplary embodiment of the present invention;

FIG. 4 is an exemplary perspective view showing a stage included in the wet device according to the second exemplary embodiment;

FIG. 5 is a flowchart showing an example of a processing procedure of a processing unit and a liquid supply control unit in a wet detection device according to the second exemplary embodiment;

FIG. 6 is a graph showing an example of a relation of a intensity level of a color signal and a reflectivity (an example of a calibration line);

FIG. 7 is an exemplary diagram showing an example of an image of a target object by an imaging device; and

FIG. 8 is an exemplary diagram showing an example of an image pixel to the image of the target object.

### EXEMPLARY EMBODIMENT

The exemplary embodiments of the present invention will be described below with reference to the drawings.

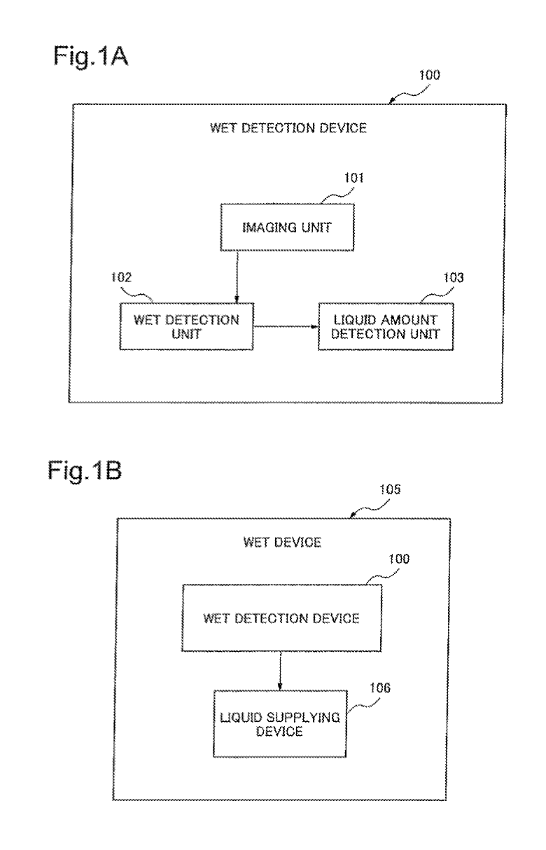

FIG. 1A is a block diagram showing a simplified configuration of a wet detection device according to a first exemplary embodiment of the present invention. The wet detection device 100 of the first exemplary embodiment includes an imaging device (imaging unit) 101, a wet detection unit 102, and a liquid amount detection unit 103. The imaging device 101 is provided with a configuration which images a target object and a standard object under the same environment. The target object is a target which detects a wet (moisture, humidity) condition. Further, the standard object is an object as a standard for a reflectivity determination. The reflectivity of the standard object is found in advance.

The wet detection unit 102 is provided with a function to detect the reflectivity of light irradiated toward the target object based on each image data of the target object and the standard object by the imaging device 102 and based on information representing the reflectivity of light irradiated toward the standard object. Further, the wet detection unit 102 is provided with a function detecting a wet condition of the target object based on the detected reflectivity.

The liquid amount detection unit 103 is provided with a function to calculate an amount of liquid compensating for a wet deficiency of the target object compared with a predetermined wet condition based on the detected wet condition of the target object.

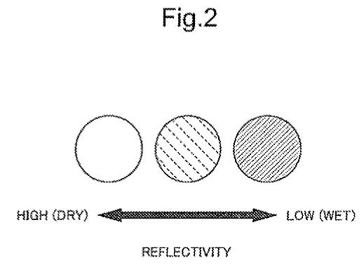

According to the first exemplary embodiment, the wet condition of the object (substance) is detected by using the reflectivity of the object (substance). That is, a reflectivity of an object, as shown in FIG. 2, becomes high in response that the degree of dryness of the object becomes higher. In other words, a reflectivity of an object becomes low in response that the degree of wetness becomes higher. Therefore, a wet condition of an object can be detected by using the reflectivity of the object. In the first exemplary embodiment, the reflectivity of the target object is detected by using the image data obtained by imaging the target object detecting a wet condition, the image data of a standard object imaged under the same environment as the target object, and the reflectivity of the standard object. For this reason, the reflectivity of the target object can be detected with high accuracy.

Thus, because the wet condition of the target object is detected based on such reflectivity detected with high accuracy, it is possible to improve the detection accuracy of the wet condition.

Further, in the first exemplary embodiment, the amount of liquid compensating for the wet deficiency of the target object compared with the predetermined wet condition can be calculated because of providing the liquid amount detection unit 103. That is, the wet detection device 100 of the first exemplary embodiment can avoid the problem of having the differences to arise for the amount of liquid compensating for the wet deficiency due to the individual differences of workers.

The wet detection device 100 of the first exemplary embodiment, as shown in FIG. 1B, can compose a wet device 105 together with a liquid supplying device 106 as described below. The liquid supplying device 106 is a device providing a function of supplying the amount of liquid detected by the wet detection device 100 to the target object.

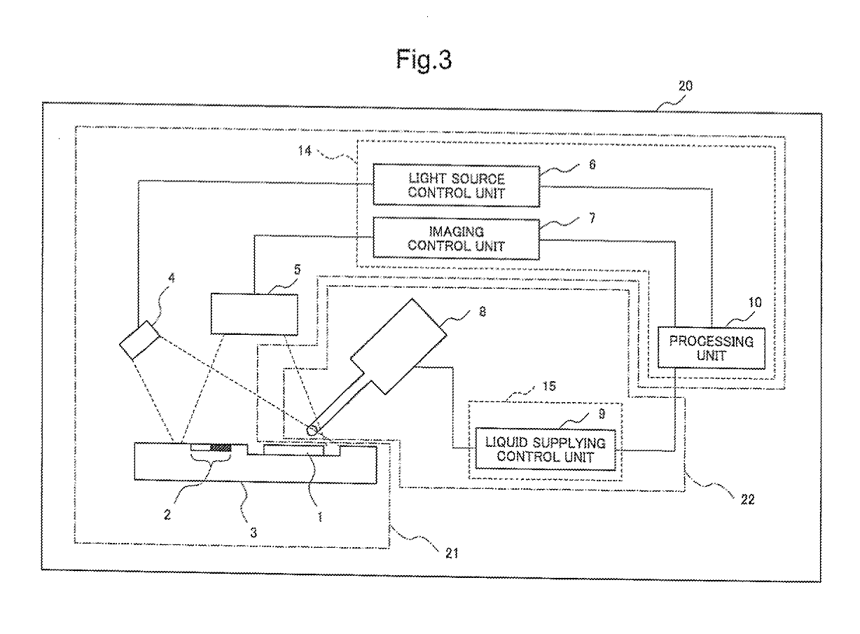

FIG. 3 is a simplified diagram showing a configuration of a wet device according to a second exemplary embodiment of the present invention. A wet device 20 of the second exemplary embodiment includes a wet detection device 21 and a liquid supplying device 22. The wet detection device 21 includes a stage 3, a light source 4, an imaging device (imaging unit) 5, a light source control unit 6, an imaging control unit 7, and a processing unit 10. The liquid supplying device 22 includes a liquid supplying unit 8 and a liquid supplying control unit 9.

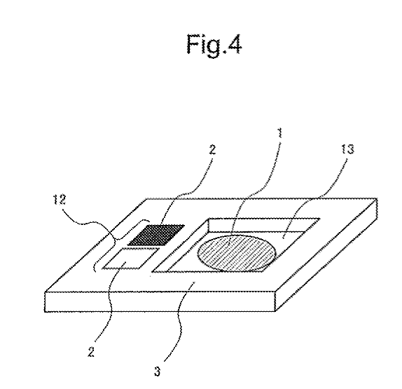

FIG. 4 is a perspective view showing the stage 3. A part 13 of the stage 3 is formed in concave. The concave part 13 is a part where a target object 1 which a wet condition is detected is set. A part 12 which is another part different from the concave part 13 of the stage 3 includes a part setting one or more of a standard plate 2 which is a standard object. The standard plate 2 is a standard when determining a reflectivity of light irradiated toward the target object 1. The reflectivity of light irradiated toward the standard plate 2 is found in advance. In the second exemplary embodiment, the standard plate 2 is pasted to the stage 3.

The light source 4 is, for example, an LED (Light Emitting Diode) light. The light source 4 irradiates both the target object 1 set on the stage 3 and the standard plate 2 by emitting light.

The light source control unit 6 controls the light source 4.

The imaging device 5 is, for example, a CCD (Charge Coupled Device) camera. The imaging device 5 images the target object 1 set on the stage 3 and the standard plate 2 at the same time. In other words, the imaging device 5 images the target object 1 set on the stage 3 and the standard plate 2 under the same environment. Further, the imaging device 5 is provided with a function to transmit an imaging signal including an imaging data to the image control unit 7.

The image control unit 7 is provided with a function to control the imaging device 5. Further, the image control unit 7 is provided with a function to generate an image data of the target object 1 and the standard plate 2 based on the imaging signal received from the imaging device 5. Furthermore, the imaging control unit 7 is provided with a function to transmit the image data to the processing unit 10.

The processing unit 10 is provided with a function to control the light source control unit 6, the imaging control unit 7 and the liquid supplying device 22. Further, the processing unit 10 is provided with a function to determine a wet condition of the target object 1 as described below. Furthermore, the processing unit 10 is provided with a function to calculate a necessary amount of liquid (in other words, the amount of liquid compensating for a wet deficiency) for becoming the target object 1 in a predetermined wet condition based on the result by the determination processing of the wet condition. Further, the processing unit 10 is provided with a function to output a signal of the level value corresponding to the calculation result to the liquid supplying device 22.

The liquid supplying device 22 includes the liquid supplying unit 8 and the liquid supplying control unit 9.

The liquid supplying unit 8 includes a structure to drop liquid. In the second exemplary embodiment, the liquid supplying unit 8 supplies (drops) a predetermined kind of liquid to the target object 1. Further, the amount which the liquid supplying unit 8 drops is the amount corresponding to the information from the liquid supplying control unit 9 as described below.

The liquid supplying control unit 9 is provided with a function to transmit information of the necessary amount of the predetermined kind of liquid for becoming the target object 1 in the predetermined wet condition on the basis of the level degree of the signal received from the processing unit 10.

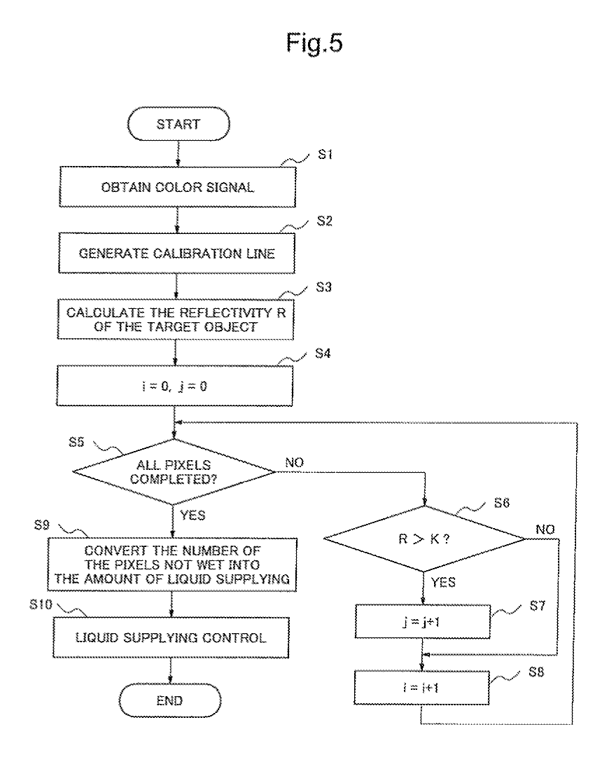

In addition, at least part (for example, the light source control unit 6, the imaging control unit 7, the processing unit 10 and the liquid supplying control unit 9) of the configuration element of the wet device 20 of the second exemplary embodiment is configured by a computer 14 and a computer 15. The computer 14 and the computer 15 realize each function of the light source control unit 6, the imaging control unit 7, the processing unit 10 and the liquid supplying control unit 9 by operating according to a computer program read from a nonvolatile storage device (not shown) such as a hard disk device installed in the wet device 20. Further, the flowchart of FIG. 5 described below represents an example of a processing procedure of a computer program executed by a computer of the wet device 20. Further, the computer program may be stored in a computer-readable recording medium such as a semiconductor memory, a CD-ROM (compact disc read only memory) or a magnetic tape.

FIG. 5 is a flowchart showing a processing procedure of the processing unit 10 and the liquid supplying control unit 9. By referring to FIG. 5 hereof, a series of the processing procedure of the processing unit 10 and the liquid supplying control unit 9 will be described below.

### (Step S1)

The processing unit 10 obtains the color signal of the target object 1 and the standard plate 2 based on the image data transmitted from the imaging control unit 7.

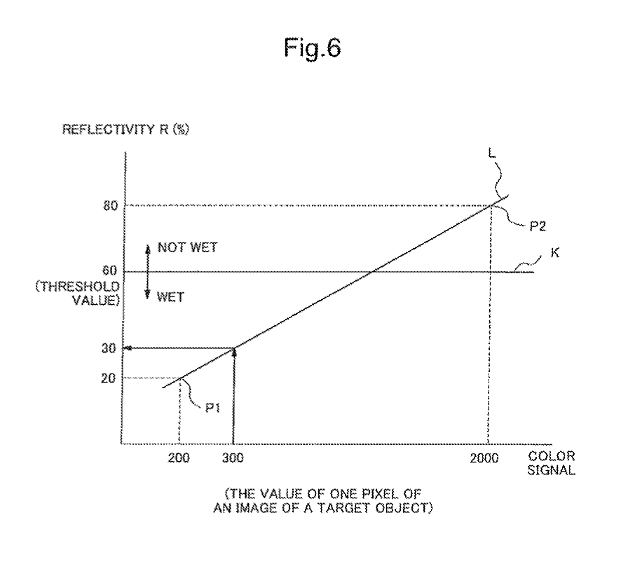

FIG. 6 is a graph showing a threshold value K and a calibration line L.

The threshold value K is a standard value used when determining whether or not the target object 1 is in a wet condition. In the second exemplary embodiment, the threshold value K is a reflectivity. The threshold value K is stored in the wet device 20 in advance.

The calibration line L is a line showing a relationship of a signal intensity level of the color signal and the reflectivity. The calibration line L is used when converting the signal intensity level of the color signal corresponding to the target object 1 into the reflectivity. The calibration line L is generated in the processing unit 10 as follows.

### (Step S2)

The processing unit 10 generates the calibration line L as follows, based on the detected color signal corresponding to the standard plate 2. For example, suppose that the standard object 2 with a reflectivity 20% and the standard object 2 with a reflectivity 80% are put on the stage 3. Here, it is supposed that the processing unit 10 detects the intensity level of the color signal corresponding to the standard object 2 with a reflectivity 20% is 200. Similarly, it is supposed that the processing unit 10 detects the intensity level of the color signal of the standard object 2 with a reflectivity 80% is 2000. As a result, Two points P1 and P2 are determined in the graph. The processing unit 10 generates a straight line which passes through the two points P1 and P2 as the calibration line L.

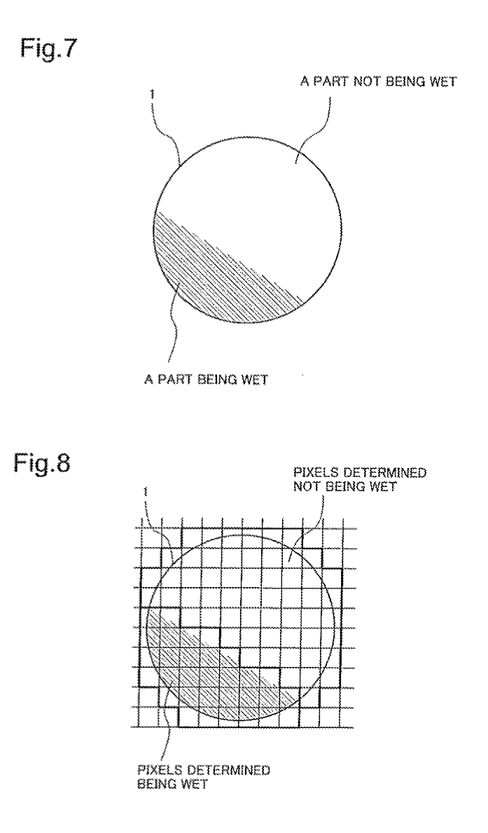

FIG. 7 is an exemplary diagram showing an example of an image of the target object 1 obtained by the imaging device 5.

FIG. 8 corresponds to the image shown in FIG. 7 and is an explanatory diagram showing an example of pixels determined being wet and pixels determined not being wet.

### (Step S3)

The processing unit 10 sets pixels to an image of the target object 1 obtained by the imaging device 5, as shown in FIG. 8. In the example of FIG. 8, the shapes of the pixels are rectangular. Further, each of the pixel size is set to occupy the predetermined area in the image of the target object 1. Such the pixels are arranged in a matrix. Further, although the pixels are shapes cut out like the mesh in the example of FIG. 8, the shapes and arrangements of the pixels may be set appropriately.

Then, the processing unit 10 converts the signal intensity level into a reflectivity R using the calibration line L shown in FIG. 6 for each pixel shown in FIG. 8 in the image of the target object 1. For example, the processing unit 10 calculates the reflectivity R of a pixel with signal intensity level 300 as 30% based on the calibration line L.

### (Step S4)

The processing unit 10 initializes a variable i and a variable j respectively. The variable i is a number in which the pixel that the wet determination processing is done is counted. The variable j is a number in which the pixel determined not being wet by the wet determination processing is counted.

### (Step S5)

The processing unit 10 determines whether the variable i reached the total numbers of pixels of the target object 1. Then, if the variable i has reached the total numbers of pixels, the processing unit 10 goes to the processing of Step S9. On the other hand, if the variable i has not reached the total number of pixels, the processing unit 10 goes to the process of Step S6.

### (Step S6)

The processing unit 10 reads the threshold value K stored in advance, and compares the threshold value K and the reflectivity R of one pixel calculated in Step S3. Then, when the processing unit 10 judges that the reflectivity R is larger than the threshold value K on the basis of the result of comparison, the processing unit 10 judges as the pixel not being wet and goes to the processing of Step S7. In contrast, when the processing unit 10 judges that the reflectivity R is not larger than the threshold value K (less than or equal to the threshold value K) on basis of the result of the comparison, the processing unit 10 judges as the pixel is wet and goes to the processing of Step S8.

### (Step S7)

The processing unit 10 added one to the variable j (the number of pixels determined as not being wet) (j=j+1) and goes to the processing of Step S8.

### (Step S8)

The processing unit 10 added one to the variable i (the number of the pixels having wet determination processing) (i=i+1) and returns to Step S5.

### (Step S9)

By having a wet determination processing of all pixels of the target object 1 completed, the processing unit 10 performs a processing as follows. That is, the processing unit 10 reads an equation stored in advance. The equation is an equation to convert the number of pixels (variable j) indicating not wet into the amount of liquid necessary for compensating a wet deficiency of the target object 1. Based on the equation, the processing unit 10 converts the variable j into the amount of liquid.

### (Step S10)

The processing unit 10 transmits a signal of the level corresponding to the amount of liquid calculated and liquid supplying command of the amount of liquid to the liquid supplying control unit 9. Then, based on the level of the signal, the liquid supplying control unit 9 transmits information on the amount of liquid for supplying (dropping) and indicates a liquid supplying to the liquid supplying unit 8. As a result, the liquid supplying unit 8 supplies predetermined kind of liquid of the amount of liquid to the target object 1.

Further, although the threshold value K shown in FIG. 6 is 60%, this is one example and the threshold value K is a numerical value set appropriately according to the substance composing the target object 1 and not limited to 60%.

The wet detection device 21 of the second exemplary embodiment can determine the wet condition of the target object 1 not by a judgment by a worker, but by an arithmetic processing based on the relation between the wet condition and the reflectivity of a target object. Therefore, the wet detection device 21 of the second exemplary embodiment can determine a wet condition of the target object 1 appropriately by eliminating the individual differences on determinations of the wet condition by the judgment of workers.

Further, the wet detection device 21 of the second exemplary embodiment uses the reflectivity of the standard plate 2 imaged together with the target object 1 as described above when detecting the reflectivity R of the target object 1. For this reason, the wet detection device 21 can reduce bad influence such as environmental changes and improve the detection accuracy of the reflectivity R of the target object 1. Consequently, the wet detection device 21 can improve the determination precision of a wet condition of the target object 1.

Further, the wet detection device 21 of the second exemplary embodiment determines the wet condition for each pixel of the target object 1. Therefore, it is possible to detect whether the target object 1 is evenly wet.

Furthermore, the wet device 20 of the second exemplary embodiment included the wet detection device 21 and the liquid supplying device 22. Therefore, when the target object is detected by the wet detection device 21 as being not evenly wet, the wet device 20 can automatically supply an appropriate amount of liquid to the target object 1 by the liquid supplying device 22.

Further, the present invention is not limited to the first or the second exemplary embodiment and various embodiments may be applied. That is, in the second exemplary embodiment, the wet detection device 21 is included in the wet device 20. However, for example, the wet detection device 21 may be included in a device which observes a chemical change between liquid and a target object. Further, the wet detection device 21 may be included in a device which detects a wet condition of a road surface. In addition, in this case, the wet detection device includes, instead of the stage 3, a standard object supporting component arranging a standard object near the road surface in order to image the standard object under the same environment with the road surface which is a target object.

Further, one of other exemplary embodiment of a wet detection device includes means for storing a reflectivity as a threshold value to determine a wet condition, means for obtaining an image data of a target object to determine a wet condition and an image data of one or more standard object having the examined reflectivity at the same time, means for detecting the reflectivity of the target object based on the image data of the target object by referring to the image data of the standard object, means for determining the wet condition of the target object by comparing the reflectivity of the target object and the reflectivity of the standard object, and means for wetting the target object to a predetermined wet condition based on the determined wet condition of the target object.

Further, one of other embodiment of a wet detecting method includes, obtaining an image data of a target object to determine a wet condition and an image data of one or more standard object having the examined reflectivity at the same time, detecting the reflectivity of the target object based on the image data of the target object by referring to the image data of the standard object, determining the wet condition of the target object by comparing the reflectivity of the target object and the reflectivity as a threshold value set on the basis of a given relation between a wet condition of a substance and a reflectivity, and wetting the target object based on the determined wet condition of the target object.

The wet detection device and the wet detecting method described above can achieve an effect as follows. That is, as it is described in the background art, various wet detection devices are proposed (for example, refer to the patent document 1-5). However, in such wet detection devices, although it is possible to detect a wet condition (a wetness degree) of a target object, it is not possible to detect the amount of liquid drop to a target object when the detected wet condition does not meet the predetermined wet condition. As a result, when a target object does not meet the predetermined wet condition, a person (worker) will judge the amount of liquid to drop (the drop amount) in order to wet a target object to meet the predetermined wet condition. Therefore, there is a problem of having the differences arise for the drop amount due to the individual differences of workers.

In contrast, in the composition of the exemplary embodiment, it is possible to accurately detect a wetness degree (a wet condition) of a target object, and moreover, it is possible to detect the necessary liquid amount for a target object in order to be in a predetermined wet condition. As a result, the configuration of the exemplary embodiment is possible to supply a proper amount of liquid to the target object.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

1. A wet detection device comprising:
an imaging unit which images a target object detecting a wet condition and a standard object as a standard for a reflectivity determination under the same environment;
a wet detection unit which detects a reflectivity of light irradiated toward the target object based on each image data of the target object and the standard object by the imaging unit and based on information representing a reflectivity of light irradiated toward the standard object found in advance, and detects a wet condition of the target object on the basis of the reflectivity of light irradiated toward the target object; and
a liquid amount detection unit which calculates an amount of liquid compensating for a wet deficiency of the target object compared with a predetermined wet condition based on the detected wet condition of the target object.

2. The wet detection device according to claim 1, wherein the wet detection unit detects the wet condition of the target object for each pixel of the image data of the target object.

3. The wet detection device according to claim 1, wherein the wet detection unit determines whether or not each pixel of the image data of the target object is wet, and
the liquid amount detection unit calculates the amount of liquid on the basis of the number of pixels determined not being wet.

4. The wet detection device according to claim 1, further comprising a light source which irradiates the light to the target object and the standard object.

5. A wet detection device comprising:
imaging means for imaging a target object detecting a wet condition and a standard object as a standard for a reflectivity determination under the same environment;
wet detection means for detecting a reflectivity of light irradiated toward the target object based on each image data of the target object and the standard object by the imaging means and based on information representing a reflectivity of light irradiated toward the standard object found in advance and detecting a wet condition of the target object on the basis of the reflectivity of light irradiated toward the target object; and
liquid amount detection means for calculating an amount of liquid compensating for a wet deficiency of the target object compared with a predetermined wet condition based on the detected wet condition of the target object.

6. A wet device comprising:
a wet detection device according to claim 1; and
a liquid supplying device which supplies an amount of liquid detected by the wet detection device to a target object.

7. A wet detecting method comprising:
imaging a target object detecting a wet condition and a standard object as a standard for the reflectivity determination under the same environment;
detecting a reflectivity of light irradiated toward the target object based on each image data of the target object and the standard object by the imaging and based on information representing a reflectivity of light irradiated toward the standard object found in advance and detecting a wet condition of the target object on the basis of the reflectivity of light irradiated toward the target object; and
calculating an amount of liquid compensating for a wet deficiency of the target object compared with a predetermined wet condition based on the detected wet condition of the target object.
